(19) United States
(12) Patent Application Publication
(10) Pub. No.: US 2013/0143046 A1
(43) Pub. Date: Jun. 6, 2013

(54) EPOXY RESIN COMPOSITION, AND PREPREG AND METAL-CLAD LAMINATE USING THE SAME

(71) Applicants: HSIEN TE CHEN, CHUPEI CITY (TW); JIUN JIE HUANG, CHUPEI CITY (TW); CHIH WEI LIAO, CHUPEI CITY (TW)

(72) Inventors: HSIEN TE CHEN, CHUPEI CITY (TW); JIUN JIE HUANG, CHUPEI CITY (TW); CHIH WEI LIAO, CHUPEI CITY (TW)

(21) Appl. No.: 13/406,316

(22) Filed: Feb. 27, 2012

(30) Foreign Application Priority Data
Dec. 6, 2011 (TW) 100144902

(51) Int. Cl. B32B 27/38; C08K 3/34; C08K 3/22; B32B 37/10; B05D 3/00; B05D 7/24; B32B 37/06; C08L 63/00; C09D 163/00

(52) U.S. Cl. 428/418; 525/122; 525/115; 525/108; 523/400; 523/467; 523/457; 427/386; 156/60

(57) ABSTRACT

Disclosed is an epoxy resin composition, which includes (A) an epoxy resin having at least two epoxy groups in one molecule; (B) a curing agent; and (C) polystyrene.

### BACKGROUND OF THE INVENTION

1. Field of the Invention

The present invention relates to an epoxy resin composition, and a prepreg and a metal-clad laminate using the epoxy resin composition, and more particularly to an epoxy resin composition, and a prepreg without entrainment of large air bubbles and a metal-clad laminate having excellent high frequency dielectric properties using the epoxy resin composition.

2. The Prior Arts

A conventional metal-clad laminate was typically manufactured via a three-step process. In the first step, a reinforcing material (for example a fiberglass cloth) was impregnated with a resin dissolved in a solvent, and followed by partially curing (B-stage) the impregnated fiberglass cloth at a temperature of not higher than 300° C. to form a prepreg. In the second step, a metal foil (for example a copper foil) was laminated onto one side or both sides of the prepreg. In the third step, the prepreg and the metal foils are bonded together with heat and pressure to form the metal-clad laminate. The printed circuit board (PCB) is thus obtained by printing an etching resist on the metal-clad laminate, etching the metal-clad laminate with the etching resist thereon, and removing the etching resist to form a predetermined circuit pattern on the metal-clad laminate. The metal-clad laminate or the printed circuit board must meet the criteria for heat resistance, dielectric properties, and chemical resistance.

The printed circuit boards are the key electronic part of portable electronic products, satellite transmission products, and communication products, and the performance of the printed circuit boards will directly influence the performance of the electronic products. However, the performance of the printed circuit boards depends on the dielectric constant (Dk) and the dissipation factor (Df) of the substrate to a great extent. As the frequency increases, the concern for signal transmitting loss increases and the effect from the signal delay becomes more significant. The signal delay is proportional to the square root of the dielectric constant of the electrical insulating material, and the transmission loss is proportional to and the dissipation factor and the square root of the dielectric constant of the electrical insulating material. Therefore, a material having low dielectric constant and low dissipation factor is required for manufacturing a high-speed-transmission printed circuit board.

In recent years, in order to improve the performance of the copper-clad laminate (CCL), researchers have proposed many different methods. For example, TW patent No. 442535 and TW patent No. 444043 disclosed that polytetrafluoroethylene, polyphenyleneoxide, functionalized-syndiotacticpolystyrene, or functionalized-syndiotacticpolystyrene copolymer was added to the resin composition in order to lower the dielectric constant of the copper-clad laminate.

However, another problem existed in the prior art is that air bubbles will be entrained into a prepreg while it is being prepared. When a particular number of such prepregs entrained with air bubbles are bonded together via heating and pressurizing to form a laminate, the laminate will have voids present between the adjacent prepregs due to the entrainment of large air bubbles in the prepregs. Consequently, the conductive anodic filament (CAF) growth in the printed circuit boards will propagate along the interface between the epoxy resin and the fiber bundles with the help of the voids under high humidity and high voltage gradient conditions, which will cause electrical shorts. Furthermore, the heat resistance of the printed circuit boards will become poor and even the popcorn phenomenon can occur due to the entrainment of air bubbles in the prepregs. However, the air bubble defects were corrected conventionally by a process operation, wherein the surface of the prepreg was pressed by hands or a roller for purging out the air bubbles from the prepreg while observing the operation with the eyes of the operator for removing air bubbles.

In addition, polystyrene is a transparent aromatic polymer that is made from the monomer styrene. It is a long hydrocarbon chain that has a phenyl group attached to every carbon atom. The commercially important form of polystyrene is atactic, which means that the phenyl groups are randomly distributed on both sides of the polymer chain. Due to the high degree of random placement of the phenyl groups relative to the backbone, polystyrene is hard and brittle, which is present in solid or glassy state at normal temperature, and has a glass transition temperature Tg of 80 to 150° C. Polystyrene has excellent electrical properties, especially at high frequencies. However, polystyrene is flammable, and has poor heat resistance. Moreover, phase separation will occur in a blend of polystyrene and epoxy resin due to the immiscibility between polystyrene and the epoxy resin.

In view of the prior art, there still exists a need for providing an epoxy resin composition that enables the metal-clad laminate using such an epoxy resin composition to have excellent high frequency dielectric properties (such as low dielectric constant, and low dielectric dissipation factor) without deteriorating the other properties of the metal-clad laminate, such as flame retardancy, and heat resistance.

### SUMMARY OF THE INVENTION

An objective of the present invention is to provide an epoxy resin composition which comprises a certain quantity of polystyrene used as an additive, and such an epoxy resin composition is capable of giving a prepreg without phase separation and without entrainment of air bubbles with a diameter of more than 100 μm, and is capable of giving a metal-clad laminate having excellent high-frequency dielectric properties, and excellent flame retardancy and heat resistance.

Another objective of the present invention is to provide a prepreg without phase separation and without entrainment of air bubbles with a diameter of more than 100 μm, which is made from such an epoxy resin composition described above.

A furthermore objective of the present invention is to provide a metal-clad laminate having excellent high-frequency dielectric properties, flame retardancy, and heat resistance, which is made from a stack of such prepregs described above.

To achieve the above objectives, the present invention provides an epoxy resin composition comprising: (A) an epoxy resin having at least two epoxy groups in one molecule; (B) a curing agent; and (C) 1 to 14 parts by weight of polystyrene, based on 100 parts by weight of the epoxy resin.

The epoxy resin composition of the present invention can further include a curing accelerator.

The epoxy resin composition of the present invention can further include an inorganic filler.

The epoxy resin composition of the present invention can further include a cyanate ester resin.

The present invention further provides a prepreg obtained by impregnating a reinforcing material with the epoxy resin composition of the present invention to form an impregnated substrate, and drying the impregnated substrate to a semi-cured state.

The present invention yet further provides a metal-clad laminate obtained by placing two or more prepregs of the present invention one over another to prepare a stack of prepregs, placing a metal foil on at least one of top and bottom surfaces of the stack of prepregs, and hot-pressing the stack of prepregs and the metal foil.

Furthermore, a printed circuit board having no copper migration and being used for high speed and high frequency transmission can be obtained by forming a particular circuit pattern on the metal foil of the metal-clad laminate of the present invention.

According to the present invention, there can be provided an epoxy resin composition having low dielectric constant and low dielectric dissipation factor, which is suitably used for manufacturing a high frequency type electronic component without deteriorating the other properties of the electronic component, such as flame retardancy and heat resistance.

The objectives, characteristics, aspects, and advantages of the present invention will become more evident in the following detailed description.

### BRIEF DESCRIPTION OF THE DRAWINGS

FIG. 1 is a 50-times-magnified photograph of the prepreg obtained in Example 2.

FIG. 2 is a 50-times-magnified photograph of the prepreg obtained in Comparative Example 2.

FIG. 3 is a 50-times-magnified photograph of the prepreg obtained in Comparative Example 3.

### DETAILED DESCRIPTION OF THE PREFERRED EMBODIMENT

In the present embodiment, the epoxy resin composition comprises: (A) 100 parts by weight of an epoxy resin having at least two epoxy groups in one molecule; (B) a curing agent, wherein the ratio of an active group equivalent of the curing agent relative to an epoxy equivalent of the epoxy resin is 0.8 to 1.2; (C) 1 to 14 parts by weight of polystyrene, based on 100 parts by weight of the epoxy resin; (D) 0.05 to 0.15 parts by weight of a curing accelerator; and (E) 60 to 120 parts by weight of an inorganic filler; and (F) 10 to 30 parts by weight of an optional additive, such as the cyanate ester resin. The parts by weight of components (B), (C), (D), (E), and (F) are based on 100 parts by weight of the epoxy resin (component (A)).

The epoxy resin (A) used in the epoxy resin composition of the present invention has at least two epoxy groups in one molecule. Examples of the epoxy resin used in the present invention include, but are not limited to, bisphenol A epoxy resin including brominated bisphenol A epoxy resin (such as tetrabromobisphenol-A epoxy resin), bisphenol F epoxy resin, bisphenol S epoxy resin, phenolic novolak epoxy resin, and cresol novolak epoxy resin such as DOPO-CNE (which is obtained by reacting 10-dihydro-9-oxa-10-phosphahenanthrene-10-oxide (DOPO) with cresol novolac epoxy resin (CNE)). These epoxy resins can be used singly or in combination of two or more of them.

The curing agent (B) used in the epoxy resin composition of the present invention can be any compound that is used for curing an epoxy resin having at least two epoxy groups in one molecule. Examples of the curing agent (B) of the present invention include, but are not limited to, dicyandiamide (DICY), 4,4′-diamino diphenyl sulfone, open-ring benzoxazine, closed-ring benzoxazine, styrene maleic anhydride copolymer (SMA), and phenolic novolak resin. These curing agents can be used singly or in combination of two or more of them. The preferred curing agent includes dicyandiamide, and styrene maleic anhydride copolymer, wherein a ratio of an active group equivalent of the curing agent relative to an epoxy equivalent of the epoxy resin is 0.8 to 1.2.

Polystyrene (C) used in the epoxy resin composition of the present invention is present in the epoxy resin composition of the present invention in an amount of from 1 to 14 parts by weight, based on 100 parts by weight of the epoxy resin. The amount of polystyrene (C) used in the epoxy resin composition is critical to the success of the manufacture of a metal-clad laminate having excellent high frequency dielectric properties without deteriorating other properties of the metal-clad laminate. Polystyrene used in the epoxy resin composition of the present invention has a weight average molecular weight of from 100,000 to 200,000.

The curing accelerator (D) used in the epoxy resin composition of the present invention can be any compound that is used for accelerating the curing of an epoxy resin. Examples of the curing accelerator used in the present invention include, but are not limited to, imidazoles, more particularly alkyl substituted imidazoles such as 2-methylimidazole and 2-ethyl-4-methylimidazole, 2-phenylimidazole, 2-phenyl, 4-methylimidazole. Other suitable accelerators include tertiary amines, e.g. benzyldimethylamine and 4,4′ and 3,3′ diaminodiphenylsulphone. These curing accelerators can be used singly or in combination of two or more of them. The preferred curing accelerator includes 2-methylimidazole. The amount of curing accelerator used is dependent on the type of epoxy resin, the type of curing agent, and the type of curing accelerator. The curing accelerator is present in the epoxy resin composition of the present invention in an amount of from 0.05 to 0.15 parts by weight, based on 100 parts by weight of the epoxy resin.

The inorganic filler (E) used in the epoxy resin composition of the present invention serves to impart additional flame retardancy, heat resistance and humidity resistance to the epoxy resin composition. Examples of the inorganic filler used in the present invention include, but are not limited to, fused silica, crystalline silica, silicon carbide, silicon nitride, boron nitride, calcium carbonate, barium sulfate, calcium sulfate, mica, talc, clay, alumina, magnesium oxide, zirconium oxide, aluminium hydroxide, magnesium hydroxide, calcium silicate, aluminum silicate, lithium aluminum silicate, zirconium silicate, and molybdenum disulfide. These inorganic fillers can be used singly or in combination of two or more of them. The preferred inorganic fillers include talc and aluminium hydroxide. The inorganic filler is present in the epoxy resin composition of the present invention in an amount of from 60 to 120 parts by weight, based on 100 parts by weight of the epoxy resin.

The optional additive (F) used in the epoxy resin composition of the present invention serves to improve the dielectric properties and thermal properties of the epoxy resin composition. Examples of the additive (F) used in the present invention include, but are not limited to, cyanate ester resin, and polyphenylene ether resin. The preferred additive includes cyanate ester resin. The additive is present in the epoxy resin composition of the present invention in an amount of from 10 to 30 parts by weight, based on 100 parts by weight of the epoxy resin.

One or more solvents can be used for preparing the epoxy resin composition varnish in the present invention in order to provide resin solubility, and control resin viscosity. Examples of the solvents used in the present invention include, but are not limited to, acetone, methylethylketone, propylene glycol methyl ether, cyclohexanone, and dimethylformamide (DMF). These solvents can be used singly or in combination of two or more of them. The preferred solvent includes dimethylformamide. The solvent is present in the epoxy resin composition of the present invention in an amount of from 50 to 150 parts by weight, based on 100 parts by weight of the epoxy resin.

If necessary, various additives such as silane coupling agents, releasants, and flame retardants can be used in the epoxy resin composition of the present invention

The epoxy resin composition of the present invention can be prepared by blending the components (A), (B), (C), (D), (E) and optional (F), and agitating the mixture uniformly, for example, in a mixer or blender.

The epoxy resin composition varnish of the present invention is prepared by dissolving or dispersing the obtained epoxy resin composition in a solvent.

A reinforcing material is impregnated with the resin varnish to form an impregnated substrate, and then the impregnated substrate is heated in a dryer at 150 to 180° C. for 2 to 10 minutes to give a prepreg in a semi-cured state (B-stage). Examples of the reinforcing material used in the present invention include, but are not limited to, fiberglass cloth, glass paper and glass mat, and also, kraft paper and linter paper.

A metal-clad laminate used for the manufacture of the printed circuit board is prepared by placing two or more prepregs of the present invention one over another to prepare a stack of prepregs, placing a metal foil on at least one of top and bottom surfaces of the stack of prepregs, and hot-pressing the stack of prepregs and the metal foil. As for the hot-pressing condition, the temperature is 160 to 190° C., the pressure is 10 to 30 kg/cm², and the hot-pressing time is 30 to 120 minutes. Examples of the metal foil used in the present invention include, but are not limited to, copper foil, aluminum foil, and stainless steel foil.

A printed circuit board is obtained by forming a circuit pattern on the metal foil on the metal-clad laminate, wherein the circuit pattern is formed by leaving the circuit pattern-forming regions on the metal foil on the metal-clad laminate and removing the other regions thereof by using the subtractive etching process.

Hereinafter, the present invention will be described in more detail with reference to Examples. It should be understood that the present invention is not restricted at all by these Examples.

### <Preparation of Epoxy Resin Composition Varnishes>

### Example 1

100 parts by weight of tetrabromobisphenol-A epoxy resin (CCP 550, manufactured by Chang Chun Plastics Co., epoxy equivalent: 320 g/eq), 2.2 parts by weight of dicyandiamide (DICY) (manufactured by Kingyorker Enterprise Co., active hydrogen equivalent: 21 g/eq), 6 parts by weight of polystyrene (manufactured by BASF Co.), and 0.05 parts by weight of 2-methylimidazole were mixed together by a mixer at room temperature for 60 minutes, and then the obtained mixture was dissolved in 80 parts by weight of dimethylformamide (DMF), followed by stirring in a disperser at room temperature for 120 minutes to give the epoxy resin composition varnish.

### Example 2

100 parts by weight of tetrabromobisphenol-A epoxy resin (CCP 550, manufactured by Chang Chun Plastics Co., epoxy equivalent: 320 g/eq), 15 parts by weight of styrene maleic anhydride copolymer (SMA EF40, manufactured by Sartomer Co., styrene:maleic anhydride ratio of 4:1, average molecular weight: 11,000, acid anhydride equivalent: 393 g/eq), 6 parts by weight of polystyrene (manufactured by BASF Co.), 0.14 parts by weight of 2-methylimidazole, 15 parts by weight of cyanate ester resin (manufactured by Lonza Group), and 40 parts by weight of talc and 40 parts by weight of aluminium hydroxide were mixed together by a mixer at room temperature for 60 minutes, and then the obtained mixture was dissolved in 80 parts by weight of DMF, followed by stirring in a disperser at room temperature for 120 minutes to give the epoxy resin composition varnish.

### Example 3

100 parts by weight of DOPO-CNE (CCP 330, manufactured by Chang Chun Plastics Co., epoxy equivalent: 360 g/eq), 2.3 parts by weight of DICY (manufactured by Kingyorker Enterprise Co., active hydrogen equivalent: 21 g/eq), 6 parts by weight of polystyrene (manufactured by BASF Co.), 0.03 parts by weight of 2-methylimidazole, and 40 parts by weight of talc and 40 parts by weight of aluminium hydroxide were mixed together by a mixer at room temperature for 60 minutes, and then the obtained mixture was dissolved in 80 parts by weight of DMF, followed by stirring in a disperser at room temperature for 120 minutes to give the epoxy resin composition varnish.

### Comparative Example 1

100 parts by weight of tetrabromobisphenol-A epoxy resin (CCP 550, manufactured by Chang Chun Plastics Co., epoxy equivalent: 320 g/eq), 2.2 parts by weight of DICY (manufactured by Kingyorker Enterprise Co., active hydrogen equivalent: 21 g/eq), and 0.05 parts by weight of 2-methylimidazole were mixed together by a mixer at room temperature for 60 minutes, and then the obtained mixture was dissolved in 80 parts by weight of DMF, followed by stirring in a disperser at room temperature for 120 minutes to give the epoxy resin composition varnish.

### Comparative Example 2

100 parts by weight of tetrabromobisphenol-A epoxy resin (CCP 550, manufactured by Chang Chun Plastics Co., epoxy equivalent: 320 g/eq), 15 parts by weight of styrene maleic anhydride copolymer (SMA EF40, manufactured by Sartomer Co., styrene:maleic anhydride ratio of 4:1, average molecular weight: 11,000, acid anhydride equivalent: 393 g/eq), 0.12 parts by weight of 2-methylimidazole, 15 parts by weight of cyanate ester resin (manufactured by Lonza Group), and 40 parts by weight of talc and 40 parts by weight of aluminium hydroxide were mixed together by a mixer at room temperature for 60 minutes, and then the obtained mixture was dissolved in 80 parts by weight of DMF, followed by stirring in a disperser at room temperature for 120 minutes to give the epoxy resin composition varnish.

### Comparative Example 3

100 parts by weight of tetrabromobisphenol-A epoxy resin (CCP 550, manufactured by Chang Chun Plastics Co., epoxy equivalent: 320 g/eq), 2.2 parts by weight of DICY (manufactured by Kingyorker Enterprise Co., active hydrogen equivalent: 21 g/eq), 15 parts by weight of polystyrene (manufactured by BASF Co.), 0.04 parts by weight of 2-methylimidazole, and 40 parts by weight of talc and 40 parts by weight of aluminium hydroxide were mixed together by a mixer at room temperature for 60 minutes, and then the obtained mixture was dissolved in 80 parts by weight of DMF, followed by stirring in a disperser at room temperature for 120 minutes to give the epoxy resin composition varnish.

### <Preparation of Prepregs>

The 7628 (R/C: 43%) fiberglass cloths (product of Nitto Boseki Co., Ltd) were respectively impregnated with the resin varnish obtained in Examples 1 to 3 and Comparative Examples 1 to 3 at room temperature, and followed by heating the impregnated fiberglass cloths at approximately 180° C. for 2 to 10 minutes to remove the solvent in the resin varnish (here, the resulting epoxy resin compositions were semi-cured) to obtain the prepregs of Examples 1 to 3 and Comparative Examples 1 to 3.

### <Preparation of Copper-Clad Laminate>

Eight prepregs (300 mm×510 mm) of Example 1 were held and laminated between two copper foils (thickness: 1 oz, product of Nikko Gould Foil Co., Ltd.), to give a laminate. The laminate was then molded under the heating/pressurization condition of the temperature of 180° C. (the programmed heating rate of 2.0° C./minutes) and the pressure of 15 kg/cm² (an initial pressure: 8 kg/cm²) for 60 minutes, to give a copper-clad laminate for a printed circuit board.

### <Preparation of Printed Circuit Board>

A circuit pattern was formed on the surface of the copper-clad laminate by leaving circuit pattern-forming regions and removing the other regions thereof by etching, and thereby a printed circuit board carrying a circuit on the surface thereof was obtained.

The copper-clad laminates and the printed circuit boards for Examples 2 to 3 and Comparative Examples 1 to 3 were respectively obtained in the same way as the above-mentioned method for preparing the copper-clad laminate and the printed circuit board of Example 1.

The properties of the copper-clad laminates obtained in Examples 1 to 3 and Comparative Examples 1 to 3 were respectively determined by the following evaluation tests.

### [Water Absorption]

The standard pressure cooker test (PCT) was done at 121° C., 100% relative humidity, and a pressure of 2 atmospheres for 1 hour.

### [Solder Floating]

The sample was kept floating on a solder bath of 288° C. for the time indicated in Table 1 and, then blister of the sample was visually observed.

### [Peeling Strength of Copper Foil]

A 1 oz of copper foil on the copper-clad laminate was peeled off for determination of its 90° peel strength (JIS-C-6481).

### [Glass Transition Temperature]

The glass transition temperature (Tg) was measured as peak temperature of tan δ at 1 Hz by a dynamic mechanical analyzer manufactured by Seiko Instruments, Inc.

### [Thermal Decomposition Temperature]

A resin was separated from a copper-clad laminate and analyzed in a thermogravimetric and differential thermal analyzer (TG-DTA). The programmed heating rate was 5° C./minute. The thermal decomposition temperature was a temperature at which the weight of the sample decreased by 5% from the initial weight.

### [Flame Retardancy]

The flame retardancy of a copper-clad laminate was evaluated by the method specified in UL 94. The UL 94 is a vertical burn test that classifies materials as V-0, V-1 or V-2.

### [Appearance Observation]

A sample having a size of 3 m² was cut out from the prepreg. It is observed whether or not air bubbles are entrained in the sample and whether or not a white crystalline precipitate is formed on the sample (phase separation) by using an optical microscope with a magnification of 50 times. It is noted that when the prepregs are entrained with air bubbles with a diameter of 100 μm or more, the laminate prepared from these prepregs will have voids present at the interface between the adjacent prepregs. Furthermore, it is noted that the white crystalline precipitate has the largest diameter of more than 50 μm, which is different from the white aggregation of inorganic filler particles which has an average diameter of less than 50 μm.

### [Dielectric Properties]

The dielectric constant and the dissipation factor at 1 GHz were measured according to the procedures of ASTM D150-87.

The epoxy resin compositions and the test results of the test items above are summarized in Table 1.

TABLE 1
Epoxy Resin Compositions

| Relative to 100 parts by weight of the | | | | | Comparative | Comparative | Comparative |
|---|---|---|---|---|---|---|---|
| epoxy resin | | Example 1 | Example 2 | Example 3 | Example 1 | Example 2 | Example 3 |
| Epoxy resin | Brominated bisphenol | 100 | 100 | — | 100 | 100 | 100 |
| | A epoxy resin | | | | | | |
| | DOPO-CNE | — | — | 100 | — | — | — |
| Curing agent | DICY | 2.2 | — | 2.3 | 2.2 | — | 2.2 |
| | SMA | — | 15 | — | — | 15 | — |
| Polystyrene | | 6 | 6 | 6 | — | — | 15 |
| Curing | 2-Methylimidazole | 0.05 | 0.14 | 0.03 | 0.05 | 0.12 | 0.04 |
| accelerator | | | | | | | |
| Additive | Cyanate ester resin | — | 15 | — | — | 15 | — |
| Inorganic | Talc and Aluminium | — | 80 | 80 | — | 80 | 80 |
| filler | hydroxide | | | | | | |
| Solvent | DMF | 80 | 80 | 80 | 80 | 80 | 80 |

Test Results

| | | | | | | Comparative | Comparative | Comparative |
|---|---|---|---|---|---|---|---|---|
| Properties | Conditions | Unit | Example 1 | Example 2 | Example 3 | Example 1 | Example 2 | Example 3 |
| Water | PCT121° C. | % | 0.35 | 0.45 | 0.42 | 0.36 | 0.34 | 0.30 |
| absorption | for 1 hr | | | | | | | |
| Solder | 288° C. | min | >10 | >10 | >10 | >10 | >10 | >10 |
| floating | | | | | | | | |
| Peeling | | lb/in | 9.5 | 8.3 | 8.7 | 9.5 | 8.4 | 8.9 |
| strength (1 oz) | | | | | | | | |
| Glass | DMA | ° C. | 165 | 220 | 185 | 165 | 220 | 167 |
| transition | | | | | | | | |
| temperature | | | | | | | | |
| Thermal | TGA | ° C. | 308 | 345 | 360 | 308 | 344 | 330 |
| decomposition | | | | | | | | |
| temperature | | | | | | | | |
| Flame | Rating | UL94 | V-0 | V-0 | V-0 | V-0 | V-0 | V-0 |
| retardancy | | | | | | | | |
| Appearance | Size 3 m² | air bubbles | No | No | No | Yes | Yes | No |
| observation | | phase | No | No | No | No | No | Yes |
| | | separation | | | | | | |
| Dielectric | Dk at | | 4.3 | 3.9 | 4.4 | 4.5 | 4.0 | 4.3 |
| constant | 1 GHz | | | | | | | |
| Dissipation | Df at | | 0.017 | 0.0090 | 0.012 | 0.020 | 0.011 | 0.014 |
| factor | 1 GHz | | | | | | | |

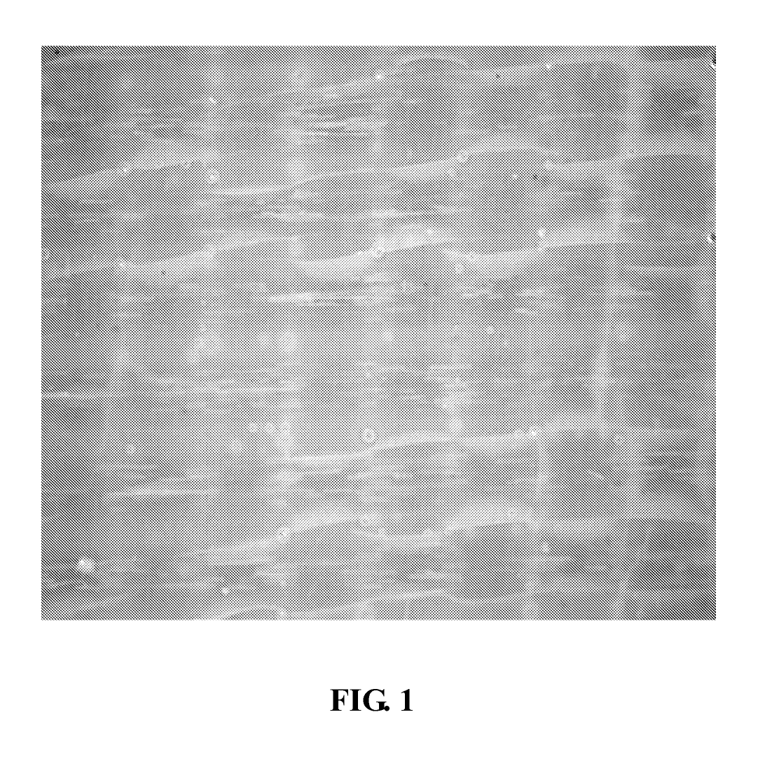

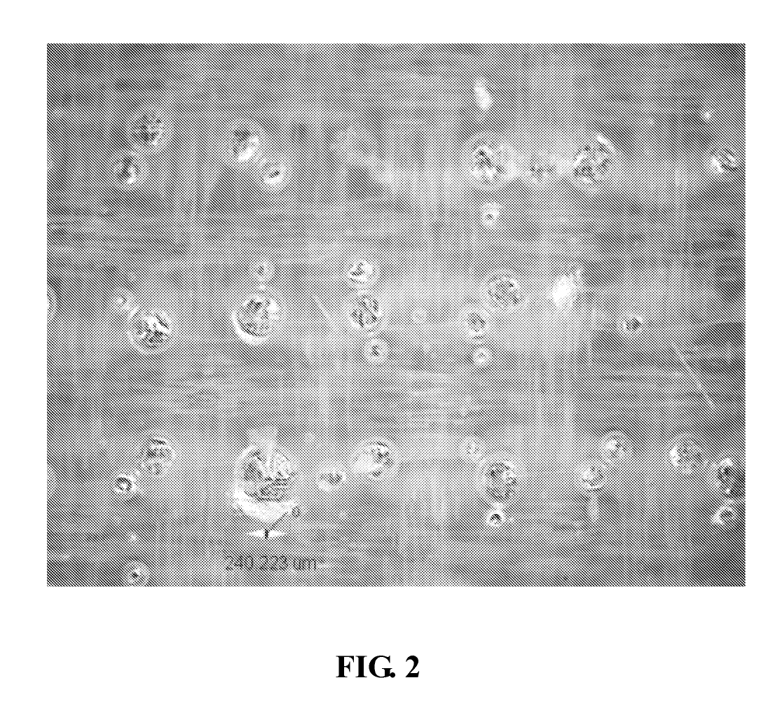

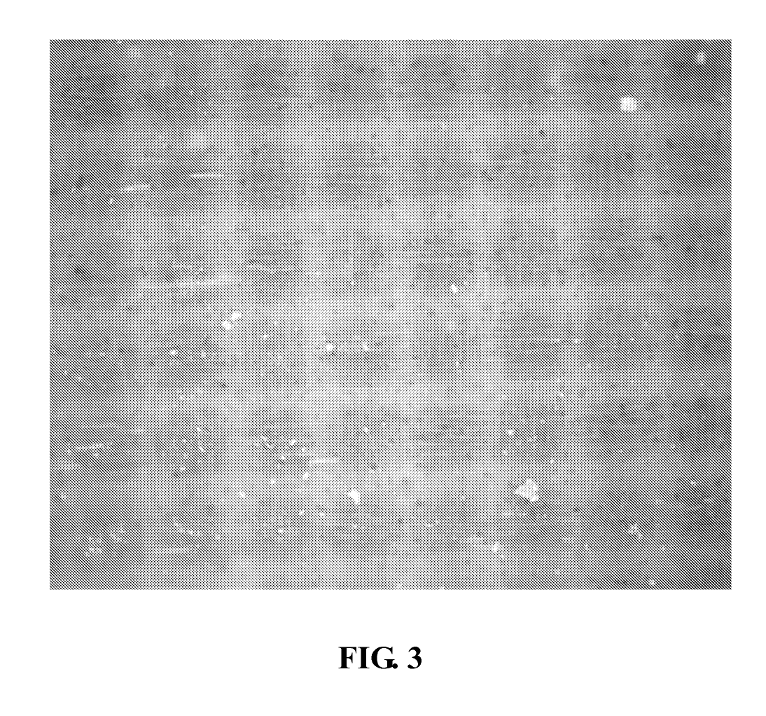

As seen from Table 1, the copper-clad laminates obtained according to the present invention (Examples 1 to 3) have the well-balanced properties and every required performance used for the high frequency printed circuit boards. In Examples 1 to 3, it shows that when the epoxy resin composition of the present invention comprises a small amount of polystyrene, phase separation (due to the immiscibility between polystyrene and epoxy resin) does not occur on the surface of the prepreg, and also air bubbles with a diameter of 100 μm or more are not entrained in the prepreg. FIG. 1 is a 50-times-magnified photograph of the prepreg obtained in Example 2. As shown in FIG. 1, although a number of small air bubbles with a diameter of less than 100 μm in the prepreg can be observed, the voids cannot be formed from these small air bubbles when a number of these prepregs are laminated into intact composite under high pressure and high temperature. The white structures as shown in FIG. 1 are the white aggregations of inorganic filler particles, and the white structures as shown in FIG. 1 have an average diameter of less than 50 μm, and it proves that phase separation does not occur on the surface of the prepreg obtained in Example 2. On the other hand, in Comparative Examples 1 and 2, it shows that when the epoxy resin composition does not comprise polystyrene, air bubbles with a diameter of 100 μm or more are entrained in the prepreg prepared from such an epoxy resin composition. FIG. 2 is a 50-times-magnified photograph of the prepreg obtained in Comparative Example 2. As shown in FIG. 2, a lot of large air bubbles with a diameter of more than 100 μm entrained in the prepreg can be observed, the voids will be formed between the adjacent prepregs from these large air bubbles. The white structures as shown in FIG. 2 are the aggregations of small air bubbles by observation. However, in the case of Comparative Example 3, it shows that when the epoxy resin composition comprises more than 14 parts by weight of polystyrene (based on 100 parts by weight of the epoxy resin) which is used to lower the dielectric constant and the dissipation factor of the laminate, phase separation occurs on the surface of the prepreg prepared from such an epoxy resin composition, but large air bubbles are not entrained in the prepreg prepared from such an epoxy resin composition. FIG. 3 is a 50-times-magnified photograph of the prepreg obtained in Comparative Example 3. As shown in FIG. 3, when more than 14 parts by weight of polystyrene (based on 100 parts by weight of the epoxy resin) is added to the epoxy resin composition, phase separation occurs by the formation of white crystalline polystyrene precipitates (i.e. the irregular white structures as shown in FIG. 3) having the largest diameter of more than 50 μm on the surface of the prepreg, but air bubbles are not entrained in this prepreg. Nonetheless, the quality of the printed circuit board, which is subsequently manufactured from the metal-clad laminate, will be affected by the white crystalline polystyrene precipitates on the prepregs.

Accordingly, the metal-clad laminates and the printed circuit boards manufactured from the epoxy resin composition of the present invention which comprises a small amount of polystyrene are excellent in dielectric properties, flame retardancy, and heat resistance, and in addition to this, the occurrence of CAF failures in the printed circuit boards manufactured from the epoxy resin composition of the present invention can be mitigated or eliminated.

It is contemplated that various modifications may be made to the epoxy resin compositions, prepregs, laminates and printed circuit boards of the present invention without departing from the spirit and scope of the invention as defined in the following claims.

What is claimed is:

1. An epoxy resin composition, comprising:
(A) an epoxy resin having at least two epoxy groups in one molecule;
(B) a curing agent; and
(C) 1 to 14 parts by weight of polystyrene, based on 100 parts by weight of the epoxy resin.

2. The epoxy resin composition as claimed in claim 1, wherein the epoxy resin is selected from the group consisting of bisphenol A epoxy resin, bisphenol F epoxy resin, bisphenol S epoxy resin, phenol novolak epoxy resin, and cresol novolak epoxy resin.

3. The epoxy resin composition as claimed in claim 2, the bisphenol A epoxy resin includes a brominated bisphenol A epoxy resin.

4. The epoxy resin composition as claimed in claim 2, the phenol novolac epoxy resin includes DOPO-CNE which is obtained by reacting 10-dihydro-9-oxa-10-phosphahenanthrene-10-oxide (DOPO) with cresol novolac epoxy resin (CNE).

5. The epoxy resin composition as claimed in claim 1, wherein polystyrene has a molecular weight of from 100,000 to 200,000

6. The epoxy resin composition as claimed in claim 1, wherein the curing agent is selected from the group consisting of dicyandiamide, and styrene maleic anhydride copolymer.

7. The epoxy resin composition as claimed in claim 1, wherein a ratio of an active group equivalent of the curing agent relative to an epoxy equivalent of the epoxy resin is 0.8 to 1.2.

8. The epoxy resin composition as claimed in claim 1, further comprising a curing accelerator.

9. The epoxy resin composition as claimed in claim 8, wherein the curing accelerator is present in an amount of from 0.05 to 0.15 parts by weight, based on 100 parts by weight of the epoxy resin.

10. The epoxy resin composition as claimed in claim 8, wherein the curing accelerator includes imidazole.

11. The epoxy resin composition as claimed in claim 1, further comprising an inorganic filler.

12. The epoxy resin composition as claimed in claim 11, wherein the inorganic filler is present in an amount of from 60 to 120 parts by weight, based on 100 parts by weight of the epoxy resin.

13. The epoxy resin composition as claimed in claim 11, wherein the inorganic filler is selected from the group consisting of talc, and aluminium hydroxide.

14. The epoxy resin composition as claimed in claim 1, further comprising a cyanate ester resin.

15. The epoxy resin composition as claimed in claim 14, wherein the cyanate ester resin is present in an amount of from 10 to 30 parts by weight, based on 100 parts by weight of the epoxy resin.

16. A prepreg obtained by impregnating a reinforcing material with the epoxy resin composition according to claim 1 to form an impregnated substrate, and drying the impregnated substrate to a semi-cured state.

17. A metal-clad laminate obtained by placing two or more prepregs according to claim 16 one over another to prepare a stack of prepregs, placing a metal foil on at least one of top and bottom surfaces of the stack of prepregs, and hot-pressing the stack of prepregs and the metal foil.
